(19) United States
(12) Patent Application Publication
(10) Pub. No.: US 2003/0069739 A1
(43) Pub. Date: Apr. 10, 2003

(54) Method for facilitating supply chain functions relating to inventory items utilizing a leased asset inventory model

(75) Inventor: Glen K. Wylie, Bridgewater, CT (US)

Correspondence Address: Philmore H. Colburn II, Cantor Colburn LLP, 55 Griffin Road South, Bloomfield, CT, 06002, US

(73) Assignee: INTERNATIONAL BUSINESS MACHINES CORPORATION, ARMONK, NY

(21) Appl. No.: 09/971,908

(22) Filed: Oct. 5, 2001

(51) Int. Cl. G06F 17/60

(52) U.S. Cl. 705/1; 705/22

(57) ABSTRACT

An exemplary embodiment of the invention relates to a method for facilitating supply chain inventory functions using a leased inventory model. The method comprises: entering into a lease agreement with a supplier of inventory items; creating an asset pool for the inventory items; periodically pulling items from the asset pool; and replacing items pulled with items of at least equal quality. The asset pool may contain raw materials for use in a manufacturing environment, finished goods for sale and/or end of life parts for use in servicing failing products. Parties to the lease agreements include a number of entities and may include a manufacturer; a supplier; a retailer; and a hub. Any of these parties may retain possession of the asset pool as well as access to the asset pool.

### BACKGROUND

This invention relates generally to supply chain inventory processes, and more particularly, the present invention relates to a leased parts inventory method in a manufacturing environment.

Businesses experiencing cash flow problems are often negatively impacted by decreased future venture capitalist investments, as well as their ability to procure loans from financial institutions for necessary capital expenditures. Banks and other lending institutions use sophisticated income-to-debt ratio formulas to determine the ability of a business to pay back its loans. Cash shortages and high debts as reflected on a business' balance sheets serve as warning flags to financial institutions of the potential instability of that business. Unfortunately, many businesses are forced to seek these investments and loans despite current debt levels in order to maintain normal everyday business operations.

One way in which businesses are changing their financing and capital planning processes is through leasing equipment instead of purchasing. By leasing the equipment instead of purchasing it, the business is able to keep these items off of their balance sheets because they do not own the equipment, and therefore, it may not be considered as debt insofar as the income-to-debt ratio analyses are concerned. Thus, the business appears to have less debt as reflected in its corporate balance sheets, creating a perception of financial stability. This solution is known as “off balance sheet financing”. One popular example of this type of financing involves the leasing of computer equipment in a business. Since the average life span of a typical computer system is shrinking due to obsolescence and changing business needs, leasing this equipment rather than purchasing it is a practical and lucrative solution for many companies.

The trade-offs involved utilizing off balance sheet financing include transferring some tax benefit to an investor or requiring a company to part with more control or ownership of its product or know-how than it would otherwise. Sometimes the trade-off is having to share more of the potential profit from an activity in order to obtain off balance sheet financing than it would if it financed the activity in another way. In other situations, off balance sheet financing is the only solution available that can keep an activity alive.

Today's manufacturing industries are struggling to reduce costs and produce goods at faster speeds, due in part to the rapidly changing global economy, and can be particularly vulnerable to the threats of cash flow fluctuations and the problems caused by increased balance sheet debt. Manufacturers of products with short life cycles, such as the electronics industry, can no longer afford the costs associated with holding onto inventories of components which can go end of life or obsolete in a short time.

Historically there has been a great deal of pressure to speed up the manufacturing process and ‘turn’ inventory more frequently. Through the years there have been many advances from fundamental model changes (e.g., the assembly line), to technological breakthroughs in automation and robotics. Aside from these ‘physical’ or ‘process’ changes, there have been advances that are more ‘financial’ in nature. These center around ‘buying’ (e.g., taking title and legal ownership) inputs at the latest possible moment and ‘selling’ (e.g., transferring title and legal ownership) output as quickly as possible. Just-in-time (JIT) inventory is one example. A later version of this concept is known as JIT Hub. The shortcomings and disadvantages of these prior art systems are further described in context of the present invention in FIGS. 1 and 2 and will become apparent therein.

Some of these costs of holding inventory include heavy taxes imposed at the time of purchase. Overages in inventory levels can create another economic burden for a manufacturer due to the associated reduction in liquid assets created by carrying excess parts. All of these costs must be carried up through the supply chain until the product is sold. Various methods of reducing inventory levels have been attempted such as Just-in-Time or Kan-ban pull methods of handling supply chain functions, as well as vendor managed inventory processes. Although many of these solutions have helped manufacturers to control inventory levels and reduce costs, they do not completely solve the problem.

Predicting inventory supply and demand and their inevitable fluctuations is not an exact science. Thus, there remains a need to facilitate supply chain processes for reducing the associated costs of manufacturing and production of goods.

### BRIEF SUMMARY

An exemplary embodiment of the invention relates to a method for facilitating supply chain inventory functions using a leased inventory model. The method comprises: entering into a lease agreement with a supplier of inventory items; creating an asset pool for the inventory items; periodically pulling items from the asset pool; and replacing items pulled with items of at least equal quality. The asset pool may contain raw materials for use in a manufacturing environment, finished goods for sale and/or end of life parts for use in servicing failing products. Parties to the lease agreements include a number of entities and may include a manufacturer; a supplier; a retailer; and a hub. Any of these parties may retain possession of the asset pool as well as access to the asset pool.

### BRIEF DESCRIPTION OF THE DRAWINGS

Referring now to the drawings wherein like elements are numbered alike in the several FIGURES:

FIGS. 1A-1C illustrate prior art supply chain inventory models;

FIGS. 2A-2D illustrate exemplary diagrams of the parts lease inventory model in four embodiments of the invention;

FIG. 3 is a flowchart illustrating the ‘buy ahead’ application of the parts lease inventory model; and

FIG. 4 is a chart illustrating a product life cycle for use in describing the ‘end of life buy’ application of the parts lease inventory model.

### DETAILED DESCRIPTION OF THE PREFERRED EMBODIMENT

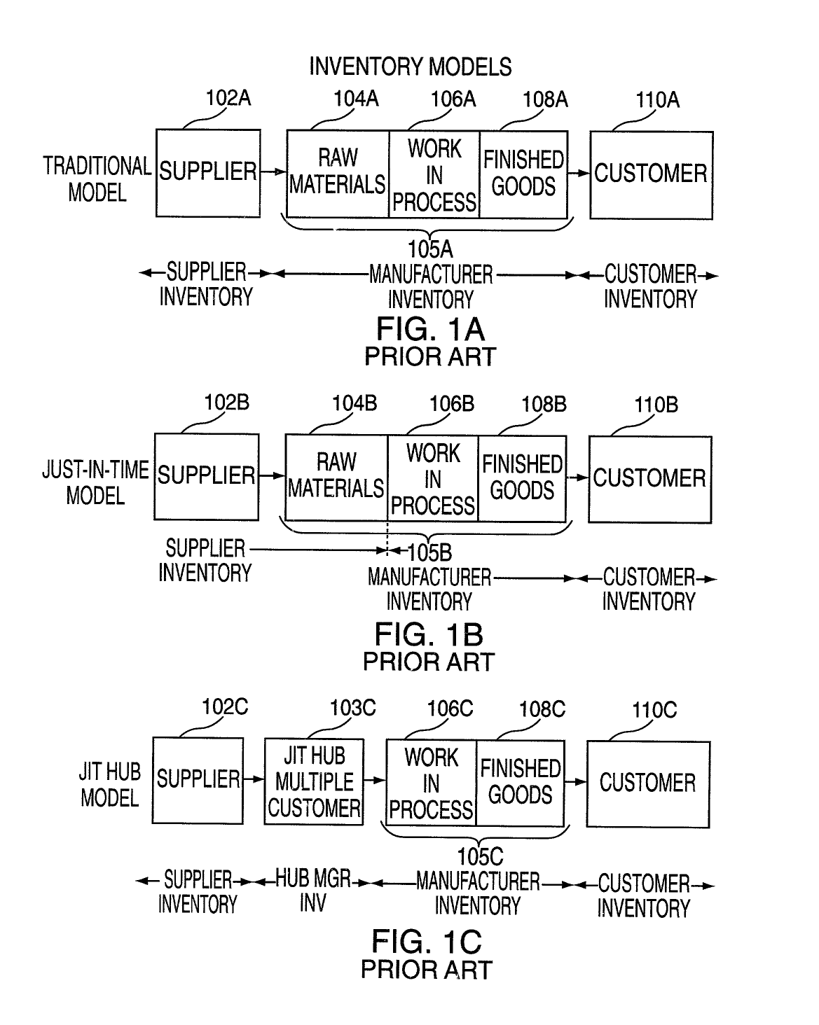

In the prior art inventory models of FIGS. 1A-1C, the traditional model (FIG. 1A) places suppliers 102A and customers 110A physically separate from the manufacturing facility 105A. Suppliers 102A and/or customers 110A can be in the building next door, just down the street, or six thousand miles away from manufacturing facility 105A. Title and ownership of raw materials 104A and finished goods 108A transfer somewhere between these locations, depending upon the shipping terms agreed upon by the parties. This separation adds time, risk, and cost to the manufacturing process as well as the entire supply chain, and may be considered to be the primary limitation of this traditional model. The JIT model of FIG. 1B shifts most of the time, risk and cost to supplier 102B as title and ownership of raw materials 104B does not transfer to manufacturing facility 105B until they are needed. Not surprisingly, over time this model can break down as supplier 102B receives less and less return on its investment while taking on the lions share of the risk. The JIT Hub model of FIG. 1C has helped share some of the time, risk, and cost with supplier 102C as the manager of hub 103C becomes a ‘broker’ in between supplier 102C and manufacturing facility 105C. This model may increase inventory turns, but it adds cost to the supply chain while reducing little risk. This is, in part, because inventory or raw materials are held off-site at hub 103C and, thus, are detached from both supplier 102C and manufacturing facility 105C who may be better equipped to control it. Supplier's 102C motivation is to fill hub 103C (e.g., to build to plan and sell as much and as fast as possible into hub 103C). The manager of hub 103C may have a similar motivation to fill hub 103C because he/she is generally paid by the number of pallets or items in the hub and how long they are kept. Manufacturing facility 105C, however, may only want to ‘pull’ from hub 103C as parts or raw materials are needed. As a result, many companies using this model are finding that their inventories swell beyond acceptable levels, oftentimes resulting in large losses as these inventories become obsolete. In the end, this additional cost is likely to be borne by manufacturing facility 105C, which may not be able to pass it on to end customer 110C.

Because inventory once housed within the factory is now off-site, the space within manufacturing facility 105C that was previously used to house the inventory is either left vacant, underutilized, or even worse, ‘filled’ with other manufacturing or storage items simply because the space has become available. Unless these companies are able to carve out and shed this space, they incur additional ‘space’ costs including rent, maintenance, utilities, security, depreciation, insurance, etc., via the hub.

Transportation costs associated with this model are likely to increase as well because now the parts have to move twice: once from the original producer or supplier to the hub and later from the hub to the manufacturing location. This translates into more storage, more handling, etc. Also because the ‘pulls’ of raw materials or finished goods are required frequently and quickly under the JIT model. This can mean additional costs and less efficiency.

Lastly, carrying costs or costs of money invested in inventory isn't eliminated via this model, but simply shifts to a third party (e.g., the hub). To the surprise of many companies, carrying costs for the outsourced inventory can be greater than what many of the larger, more sophisticated manufacturers would pay. This isn't surprising as many of these consolidators may be newer companies forming or growing via acquisition. Their access to capital markets and low cost borrowing may be restricted because they are newly formed companies or expanding to capture the market and their mainline business cannot support the growth or additional investment. As a result, they are often undercapitalized for the size of the inventory they ‘care’ for so their cost of money is normally much greater than either the supplier or the manufacturer. It's not uncommon for an established manufacturer to enjoy incremental borrowing rates of mid to low single digits, while a hub manager may be forced to charge a significant rate in order to cover their cost of money and turn a profit. For large scale inventories, this translates to potentially huge additional costs.

While achieving the benefit of greater inventory turns, cash conversion cycles and freeing up cash for growth or investment, the bottom-line costs associated with prior art inventory models continue to increase without reducing much of the risk. The parts lease inventory model of the invention addresses many of these concerns by physically locating the inventory back with the manufacturer who is best able to manage it and by providing a ‘move once’ practice relating to raw materials and finished goods, reducing cost of money issues and utilizing existing space.

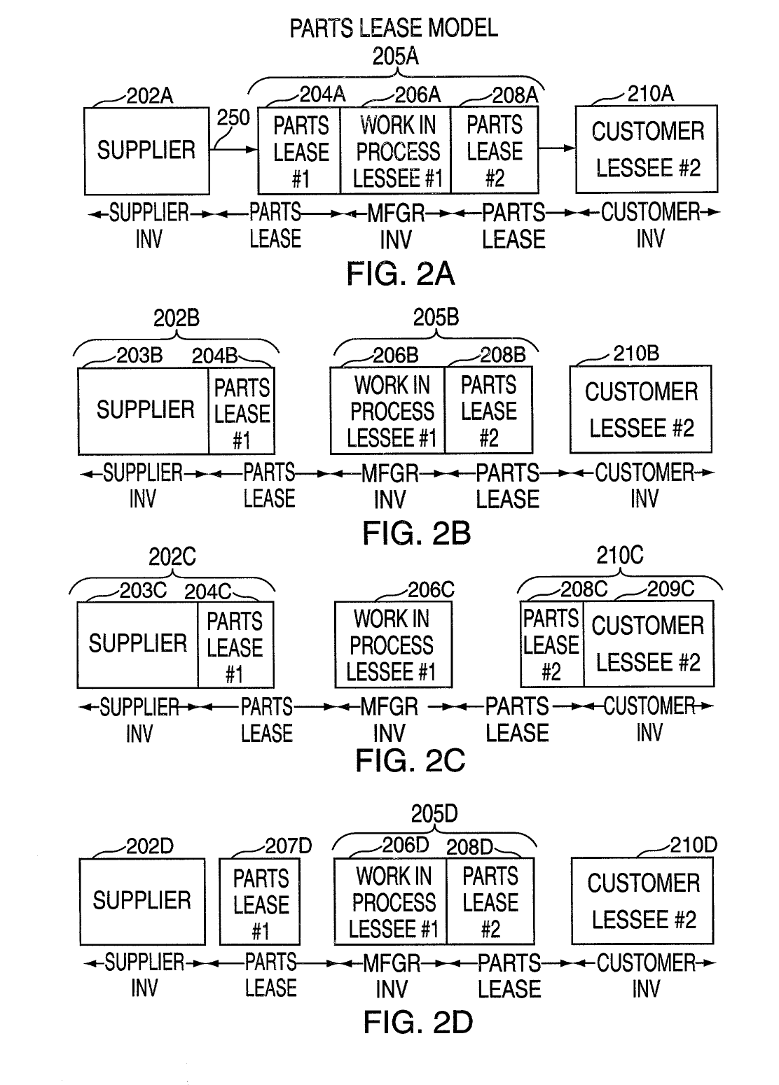

Four embodiments of the parts lease inventory model are described in FIGS. 2A-2D. FIGS. 2A-2D illustrate various blocks representing physical entities including supplier facilities 202A-202D, manufacturing facilities 205A, 205B, 206C and 205D, customer facilities 210A-210D, and a hub facility 207D. Supplier entities 202A-202D may be supply chain partners (also referred to as trading partners) of manufacturing facilities 205A, 205B, 206C, and 205D, respectively. Supplier entities 202A-202C provide raw materials directly to manufacturing facilities 205A, 205B, and 206C pursuant to an agreement between the parties, and supplier facility 202D provides raw materials to a third party (e.g., hub 207D) for storage and subsequent transfer to manufacturing facility 205D. Manufacturing facilities 205A, 205B, 206C and 205D receive raw materials for use in their manufacturing processes for subsequent sale in the form of finished goods to customers 210A-210D. In one embodiment, each of manufacturing facilities 205A, 205B, 206C, and 205D may be a contract manufacturer who assembles parts for subsequent sale or transfer to customer facilities 210A-210D which in turn, represent original equipment manufacturers (OEMs). In a second embodiment, manufacturing facilities 205A, 205B, 206C and 205D each represent a general manufacturing company which sells finished products to retail customers 210A-210D. A number of other suitable business relationships may be established and employ the parts lease inventory model of the invention.

Blocks 202-210 of FIGS. 2A-2D represent not only the entities utilizing the parts lease inventory model which are described above, but also represent the physical location of raw materials and/or finished goods. For example, in FIG. 2A, manufacturing facility 205A possesses raw materials 204A on site or at a local warehouse as displayed by adjoining blocks 204A and 206A. The significance of this representation will become apparent to the reader further herein. Blocks 204A-204C and 207D illustrate the physical location of raw materials during a lease period, and is referred to in FIGS. 2A-2D as ‘parts lease #1’. Parts lease #1 provides for title of raw materials to remain with the lessor party, shown in FIGS. 2A-2C to be supplier facilities 202A-202C, respectively, and hub facility 207D of FIG. 2D.

Parts lease #2 of blocks 208A-208D represent a second parts lease that may be used between manufacturing facilities 205A, 205B, 206C, and 205D and customer facilities 210A-210D. Although not shown in FIGS. 2A-2D, a hub entity similar to hub 207D may be used between any of the manufacturing facilities and supplier facilities shown in FIGS. 2A-2D in order to realize the advantages of the present invention. Parts lease #2 functions similar to that described in parts lease #1 except that customer facilities 210A-210D pull finished products pursuant to a lease between themselves as lessees #2 and either manufacturing facilities 205A, 205B, 206C, and 205D as shown in FIGS. 2A-2D or a hub entity (not shown) standing between the manufacturing facilities and the supplier facilities.

Below blocks 202A-202D and 210A-210D in each of FIGS. 2A-2D are representations of points in time through which one or more leases are in effect. For example, in FIG. 2A, raw materials are transferred (250) from supplier facility 202A and are physically stored at or near manufacturing facility 205A as shown by adjoining blocks 204A and 206A. As indicated below the blocks, these raw materials become subject to a lease agreement (lease #1) upon leaving supplier facility 202A up to a point in time when manufacturing facility needs to consume a number of them during a manufacturing process (shown in block 206A) at which time manufacturing facility 205A then owns the consumed items. The leased pool of raw materials 204A that are subject to lease #1 is restocked with ‘like-kind’ items so that the pool as a leased asset remains intact. The same process occurs on the other side of manufacturing facilities 205A, 205B, 206C and 205D via parts lease #2 except that the subject of the pool may include replacement parts for goods carried by customers 210A-210D or finished products. Likewise, once items are pulled by customers 210A-210D as shown in blocks 210A, 210B, 209C and 210D, they are replaced in the pool with items of like kind pursuant to the terms of the lease agreement. Lease terms and conditions may vary between lease types such as lease #1 and lease #2 as the needs of each trading partner differ. For example, a retailer or customer subject to lease #2 may desire a longer term lease in order to administer long-term parts servicing and maintenance needs for its customers whose products require longer, sustained servicing needs.

Commonly recognized leasing principles apply to the leases utilized in the parts lease inventory model which must comply with various tax laws and accounting procedures in order to be effective and recognized as true leases. Those which do not comply may not enjoy the financial and tax advantages that leases offer which are described above. For example, in the United States various laws require that a lease must be in writing and span a duration of a period greater than twelve months in order to qualify as a true lease. Also, the terms of a lease may not provide for a nominal payoff at the end of the lease term. The buyout at the lease end must meet a minimum percentage of the value of the subject of the lease. Because items contained within the lease pool are periodically consumed, the lease terms should include a requirement that any items pulled from the lease pool must be replaced with items of ‘like kind’ within a specified time period. This requirement is necessary to protect the integrity of the pool. ‘Like kind’ replacements are generally items of equal or greater quality.

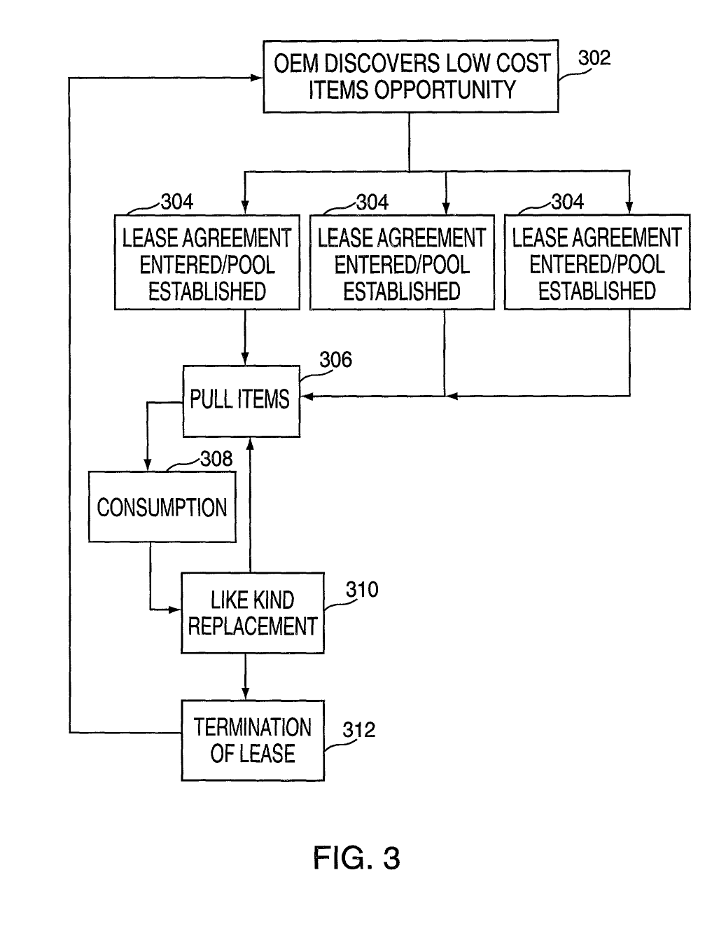

FIG. 3 illustrates the ‘buy ahead’ environment implementing the parts lease inventory method. This sub-process or application involves taking advantage of market conditions to buy more parts than can be consumed (e.g., low pricing due to over supply) and holding them for later when the prices are higher. One advantage of utilizing the parts lease inventory model to this application is that the ‘holding’ cost normally associated with storing inventory can be reduced by transferring the parts to a financing entity. An example of a buyout application utilizing the parts lease inventory model is described as follows. A manufacturer discovers a significant price reduction for one or more parts of interest at step 302. The manufacturer may not possess an immediate need for this item at this point in time and/or the item may be reduced in price for those who purchase large, bulk quantities. The manufacturer wishing to take advantage of the low prices, enters into one or more lease agreements with the supplier of the items or a third party at step 304. By entering into multiple smaller lease agreements rather than one large lease agreement, the manufacturer is able to manipulate the lease terms and duration in a favorable manner. At step 306, the manufacturer selectively pulls a number of items from the lease pool at a time when they are needed and uses these items in its manufacturing processes at step 308. Identical numbers of like kind items are then ordered and replaced in the lease pool at step 310. Steps 306-310 may be repeated as necessary until the lease terminates at step 312. The manufacturer can pursue future leases as new and low cost items enter the market whereby the process begins again at step 302.

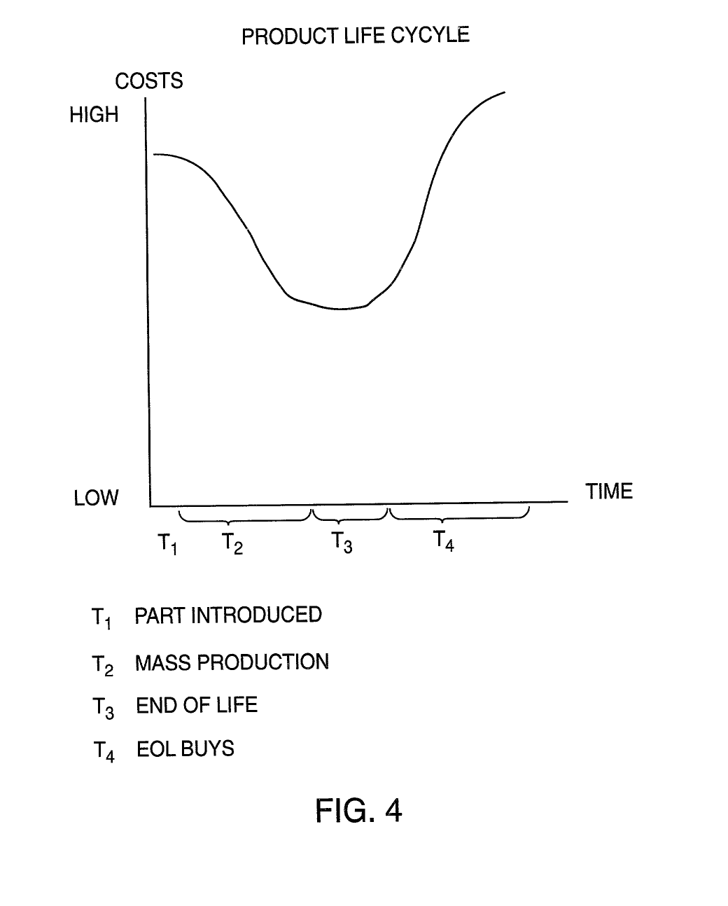

FIG. 4 illustrates the EOL buy environment whereby the parts lease inventory model may be implemented by a manufacturer or other purchasing entity. In a typical product evolution cycle, products and their parts become obsolete and need to be replaced by newer and better technology. However, some customers may resist moving over to the newer technology. This results in an abundance of older parts/products that require servicing. Many times companies will do a last-time build, often many thousands of parts, that must be held somewhere until needed. Again, it is the cost of holding these parts that can be reduced by transferring them to the financing entity and creating a parts lease. As shown in FIG. 4, a product life cycle represented by two axes (cost and time) reflects the fluctuations in the cost of parts over time periods T1 through T4. At T1, a new part is introduced into the market. At this point in time, costs associated with manufacturing this part are generally high due in part to new technology used in the manufacture as well as high demand and low supply. T2 represents a span of time whereby a desirable part goes into mass production, driving down the costs of manufacture. T3 represents a drop off period when the market has been saturated with this product and sales have dropped off. T4 represents a time period in which the part has gone ‘end of life’, possibly due to new and better parts resulting in a high demand over time for replacement services for existing products which incorporate these parts. Service entities, product manufacturers, and retailers of goods find that they are in need of large quantities of what are now ‘difficult to find’ parts. The parts lease inventory model of the invention may be particularly well-suited to administer to this end-of-life event because of its ‘like-kind’ replacement principle which provides that equal or better quality parts replace those consumed in the pool. For example, a pool of hard drives which are certain to eventually become obsolete are used up and may be replaced by upgraded hard drives that will be needed in the future for servicing newer products on the market.

While preferred embodiments have been shown and described, various modifications and substitutions may be made thereto without departing from the spirit and scope of the invention. Accordingly, it is to be understood that the present invention has been described by way of illustration and not limitation.

1. A method for facilitating supply chain inventory functions using a leased inventory model, comprising:
entering into a lease agreement with a supplier of inventory items;
creating an asset pool of said inventory items;
periodically pulling items from said asset pool; and
replacing items pulled from said asset pool with items of at least equal quality.

2. The method of claim 1, wherein said asset pool contains raw materials for use in a manufacturing environment.

3. The method of claim 1, wherein said asset pool contains finished goods for sale.

4. The method of claim 1, wherein said asset pool contains end of life parts for use in servicing failing products.

5. The method of claim 1, wherein a party to said lease agreement related to said asset pool includes one or more of:
a manufacturer;
a supplier;
a retailer; and
a hub.

6. The method of claim 5, wherein said asset pool is located at a facility associated with said manufacturer, wherein said manufacturer controls access to said asset pool.

7. The method of claim 5, wherein said asset pool is located at a facility associated with said supplier, wherein said supplier controls access to said asset pool.

8. The method of claim 5, wherein said asset pool is located at a facility associated with said retailer, wherein said retailer controls access to said asset pool.

9. The method of claim 5, wherein said asset pool is located at a facility associated with said hub, wherein said hub controls access to said asset pool.
